(19) United States
(12) Patent Application Publication
(10) Pub. No.: US 2024/0373331 A1
(43) Pub. Date: Nov. 7, 2024

(54) METHOD AND ELECTRONIC DEVICE TO ACCESS A STAND-ALONE NON-PUBLIC NETWORK (SNPN) IN FORBIDDEN SNPN (FSNPN) LIST OR FORBIDDEN TRACKING AREA IDENTITY (FTAI) LIST

(71) Applicant: MediaTek Singapore Pte. Ltd., Singapore (SG)

(72) Inventors: Puneet, Bengaluru KA (IN); Yuan-Chieh Lin, Hsinchu City (TW)

(21) Appl. No.: 18/649,780

(22) Filed: Apr. 29, 2024

(30) Foreign Application Priority Data
May 5, 2023 (IN) 202321032094
Sep. 15, 2023 (IN) 202321062227

(51) Int. Cl. H04W 48/16

(52) U.S. Cl. CPC H04W 48/16

(57) ABSTRACT

A method to access a stand-alone non-Public network (SNPN) in a forbidden SNPN (FSNPN) and a forbidden tracking area identity (FTAI) list is provided. The method is applied to a mobile station (MS). The method includes the following steps. An SNPN selection mode procedure is performed to camp on a cell of a user selected SNPN. It is determined that the selected SNPN is present in the FSNPN list or a tracking area identity (TAI) of the camped cell is in the FTAI list. An SNPN is selected by a user. Contents of FSNPN list and the FTAI list for the selected SNPN are ignored. Registration on the selected SNPN is initiated using specific access technology.

### CROSS REFERENCE TO RELATED APPLICATIONS

This application claims priority of India patent application No. 202321032094, filed on May 5, 2023, and India patent application No. 202321062227, filed on Sep. 5, 2023, the entirety of which is incorporated by reference herein.

### BACKGROUND OF THE INVENTION

### Field of the Invention

The present invention relates to a method to access a stand-alone non-public network (SNPN), and, in particular, to a method and an electronic device to access an SNPN in a forbidden SNPN (FSNPN) list or forbidden tracking area identity (FTAI) list.

### Description of the Related Art

A mobile station (MS) operating in SNPN access operation mode over 3GPP access shall perform an SNPN selection process or an SNPN selection process for onboarding services. In the current specification, when a user selects an SNPN manually—either for SNPN selection or SNPN selection for onboarding services—the initial registration procedure (in case of SNPN selection), mobility registration update (in case of SNPN selection) or the SNPN onboarding registration (in case of SNPN selection for onboarding services) may fail under the following conditions.

First, the selected SNPN is present in a list of temporarily forbidden SNPNs or a list of permanently forbidden SNPNs. Second, there is no tracking area identity (TAI) available for the selected SNPN other than TAIs present in a list of 5GS forbidden tracking areas for roaming or a list of 5GS forbidden tracking areas for regional provision of service.

Considering the above facts and UE behavior, manual SNPN selection mode procedure (or manual SNPN selection mode procedure for onboarding services) may not be able to obtain normal services, and may lead to poor user experience.

### BRIEF SUMMARY OF THE INVENTION

An embodiment of the present invention provides a method to access a stand-alone non-Public network (SNPN) in a forbidden SNPN (FSNPN) list or a forbidden tracking area identity (FTAI) list. The method is applied to a mobile station (MS). The method includes the following steps. An SNPN selection mode procedure is performed to camp on a cell of a user selected SNPN. It is determined that the selected SNPN is present in the FSNPN list or a tracking area identity (TAI) of the camped cell is in the FATI list. An SNPN is selected by a user. Contents of the FSNPN list and the FTAI list for the selected SNPN are ignored. Registration on the selected SNPN is initiated using specific access technology.

According to the method described above, the step of performing the SNPN selection mode procedure to camp on the user selected SNPN includes the following step. The selected SNPN is selected through a manual SNPN selection mode procedure.

According to the method described above, the step of performing the SNPN selection mode procedure to camp on the user selected SNPN includes the following step. The selected SNPN is selected through a manual SNPN selection mode procedure for onboarding services.

According to the method described above, the step of determining that the selected SNPN is present in the FSNPN list or the TAI of the camped cell is in the FATI list includes the following step. It is determined that the selected SNPN belongs to a list of temporarily forbidden SNPNs, or permanently forbidden SNPNs, or permanently forbidden SNPNs for access for localized services in SNPN or temporarily forbidden SNPNs for access for localized services in SNPN or temporarily forbidden SNPNs for onboarding services or permanently forbidden SNPNs for onboarding services or 5GS forbidden tracking areas for roaming, or 5GS forbidden tracking areas for regional provision of service.

An embodiment of the present invention also provides a method to access an SNPN. The method is applied to an MS. The method includes the following steps. Access to an SNPN providing access for localized services in SNPN is supported. The MS is in a manual SNPN selection mode. The MS indicates to a user whether an available SNPN is present in a list of temporarily forbidden SNPNs for access for localized services in the second SNPN, or a list of permanently forbidden SNPNs for access for localized services in the second SNPN associated with each entry of a list of subscriber data or public land mobile network (PLMN) subscription.

According to the method described above, the SNPN providing access for localized services in the SNPN belongs to a list of permanently forbidden SNPNs for access for localized services in SNPN, or a list of temporarily forbidden SNPNs for access for localized services in SNPN associated with each entry of the list of subscriber data or PLMN subscription.

According to the method described above, initiation of registration includes an initial registration procedure, or a mobility registration update procedure, or an initial registration procedure for onboarding services, or a mobility registration update procedure for onboarding services.

The method further includes the following step. The contents of lists of temporarily forbidden SNPNs for onboarding services and permanently forbidden SNPNs for onboarding services are ignored.

An embodiment of the present invention also provides an electronic device including a processor. The processor performs a stand-alone non-Public network (SNPN) selection mode procedure to camp on a cell of a user selected SNPN, determines that the selected SNPN is present in an FSNPN list or a TAI of the camped cell is in a FTAI list, ignores contents of the FSNPN list and the FTAI list for an SNPN selected by a user, and initiate registration on the selected SNPN.

According to the electronic device described above, the processor selects the selected SNPN through a manual SNPN selection mode procedure.

According to the electronic device described above, the processor selects the selected SNPN through a manual SNPN selection mode procedure for onboarding services.

According to the electronic device described above, the processor determines that the selected SNPN belongs to a list of temporarily forbidden SNPNs, or permanently forbidden SNPNs, or permanently forbidden SNPNs for access for localized services in SNPN, or temporarily forbidden SNPNs for access for localized services in SNPN, or 5GS forbidden tracking areas for roaming, or 5GS forbidden tracking areas for regional provision of service.

According to the electronic device described above, the processor ignores the contents of lists of temporarily forbidden SNPNs, permanently forbidden SNPNs, permanently forbidden SNPNs for access for localized services in SNPN, temporarily forbidden SNPNs for access for localized services in SNPN, 5GS forbidden tracking areas for roaming, and 5GS forbidden tracking areas for regional provision of service.

According to the electronic device described above, when the processor supports access to a SNPN providing access for localized services in the SNPN, the processor indicates to a user whether an available SNPN is present in a list of temporarily forbidden SNPNs for access for localized services in the SNPN, or a list of permanently forbidden SNPNs for access for localized services in the SNPN associated with each entry of a list of subscriber data or public land mobile network (PLMN) subscription.

According to the electronic device described above, the SNPN providing access for localized services in the SNPN belongs to a list of permanently forbidden SNPNs for access for localized services in the SNPN, or a list of temporarily forbidden SNPNs for access for localized services in the SNPN associated with each entry of the list of subscriber data or PLMN data.

According to the electronic device described above, the processor determines that the selected SNPN belongs to a list of temporarily forbidden SNPNs, or permanently forbidden SNPNs, or 5GS forbidden tracking areas for roaming, or 5GS forbidden tracking areas for regional provision of service, or permanently forbidden SNPNs for access for localized services in the SNPN, or temporarily forbidden SNPNs for access for localized services in the SNPN.

According to the electronic device described above, the processor ignores the contents of lists of temporarily forbidden SNPNs, permanently forbidden SNPNs, 5GS forbidden tracking areas for roaming, 5GS forbidden tracking areas for regional provision of service, permanently forbidden SNPNs for access for localized services in the SNPN, and temporarily forbidden SNPNs for access for localized services in the SNPN.

According to the electronic device described above, the processor determines that the selected SNPN belongs to a list of temporarily forbidden SNPNs for onboarding services, or permanently forbidden SNPNs for onboarding services, or 5GS forbidden tracking areas for roaming, or 5GS forbidden tracking areas for regional provision of service.

According to the electronic device described above, the processor ignores the contents of lists of temporarily forbidden SNPNs for onboarding services, permanently forbidden SNPNs for onboarding services, 5GS forbidden tracking areas for roaming, and 5GS forbidden tracking areas for regional provision of service.

### BRIEF DESCRIPTION OF THE DRAWINGS

The present invention can be more fully understood by reading the subsequent detailed description and examples with references made to the accompanying drawings, wherein:

FIG. 1 shows a flow chart of a method to access a stand-alone non-Public network (SNPN) in a forbidden SNPN (FSNPN) list and a forbidden tracking area identity (FTAI) list in accordance with some embodiments of the present invention;

FIG. 2 shows a detail flow chart of the method to access the SNPN in the FSNPN list and the FTAI list in FIG. 1 in accordance with some embodiments of the present invention;

FIG. 3 shows a detail flow chart of the method to access the SNPN in the FSNPN list and the FTAI list in FIG. 1 in accordance with some embodiments of the present invention;

FIG. 4 shows a flow chart of a method to access the SNPN in the FSNPN list and the FTAI list in accordance with some embodiments of the present invention;

FIG. 5 shows schematic diagrams of a communication system 500 in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” or “include” used in the present invention are used to indicate the existence of specific technical features, values, method steps, operations, units or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, or materials used in specific embodiments. However, the drawings should not be construed as defining or limiting the scope or properties encompassed by these embodiments. For example, for clarity, the relative size, thickness, and position of each layer, each area, or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, “third”, “fourth”, “fifth”, and “sixth” are used to describe components. They are not used to indicate the priority order of or advance relationship, but only to distinguish components with the same name.

It should be noted that the technical features in different embodiments described in the following can be replaced, recombined, or mixed with one another to constitute another embodiment without depart in from the spirit of the present invention.

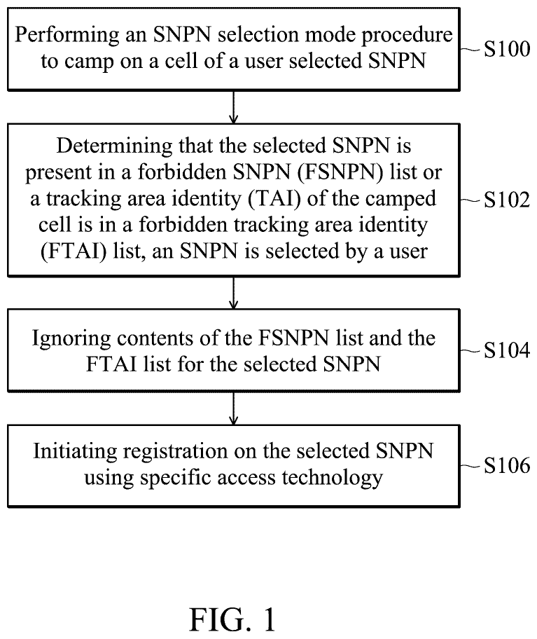

FIG. 1 shows a flow chart of a method to access a stand-alone non-Public network (SNPN) in a forbidden SNPN (FSNPN) list and a forbidden tracking area identity (FTAI) list in accordance with some embodiments of the present invention. The method of the present invention in FIG. 1 is applied to an electronic device, such as user equipment (UE). In some embodiments, the UE may be a laptop, a tablet, or a smart phone, but the present invention is not limited thereto. In some embodiments, the UE is included in a communication system, which further includes a base station. The UE is able to access a network through the base station. The UE is connected with the base station by Radio Resource Control (RRC) signaling, but the present invention is not limited thereto. In some embodiments, the base station may be a gNB, but the present invention is not limited thereto.

As shown in FIG. 1, the method to access the SNPN in the FSNPN list and the FTAI list includes the following steps. An SNPN selection mode procedure is performed to camp on a cell of a user selected SNPN (step S100). It is determined that the selected SNPN is present in the FSNPN list or a tracking area identity (TAI) of the camped cell in the FTAI list. An SNPN is selected by a user (step S102). Contents in the FSNPN list and the FTAI list for the selected SNPN are ignored (step S104). Registration on the selected SNPN is initiated using specific access technology (step S106). In some embodiments, the method of the present invention selects the selected SNPN through a manual SNPN selection mode procedure or a manual SNPN selection mode procedure for onboarding services in step S100. In step S102, if the method of the present invention selects the selected SNPN through the manual SNPN selection mode procedure, and determines that the selected SNPN belongs to a list of temporarily forbidden SNPNs, or permanently forbidden SNPNs, or permanently forbidden SNPNs for access for localized services in SNPN, or temporarily forbidden SNPNs for access for localized services in SNPN, or 5GS forbidden tracking areas for roaming, or 5GS forbidden tracking areas for regional provision of service, the method of the present invention determines the selected SNPN is not a suitable cell.

Next, in step S104, the method of the present invention ignores the contents of lists of temporarily forbidden SNPNs, permanently forbidden SNPNs, permanently forbidden SNPNs for access for localized services in SNPN, temporarily forbidden SNPNs for access for localized services in SNPN, 5GS forbidden tracking areas for roaming, and 5GS forbidden tracking areas for regional provision of service. In some embodiments, the method of the present invention further determines whether the selected SNPN in step S100 is selected by a user before step S104 is performed. If the answer is yes, the method of the present invention performs step S104 and the subsequent step S106. If the answer is no, the method of the present invention enters to a limited service state. After that, since the contents of lists of temporarily forbidden SNPNs, permanently forbidden SNPNs, permanently forbidden SNPNs for access for localized services in SNPN, temporarily forbidden SNPNs for access for localized services in SNPN, 5GS forbidden tracking areas for roaming, and 5GS forbidden tracking areas for regional provision of service are ignored or are not considered, the method of the present invention initializes registration on the selected SNPN in step S106.

In some embodiments, if the method of the present invention selects the selected SNPN through the manual SNPN selection mode procedure in step S100, and supports access to an SNPN providing access for localized services in the selected SNPN, the method of the present invention indicates to a user whether an available SNPN is present in a list of temporarily forbidden SNPNs for access for localized services in the SNPN, or a list of permanently forbidden SNPNs for access for localized services in the SNPN associated with each entry of a list of subscriber data or public land mobile network (PLMN) data. If the answer is yes, the method of the present invention selects the available SNPN as the selected SNPN in step S100. After that, in step S102, if the method of the present invention determines that the selected SNPN belongs to a list of temporarily forbidden SNPNs, or permanently forbidden SNPNs, or 5GS forbidden tracking areas for roaming, or 5GS forbidden tracking areas for regional provision of service, or permanently forbidden SNPNs for access for localized services in the SNPN, or temporarily forbidden SNPNs for access for localized services in the SNPN, the method of the present invention determines the selected SNPN is not a suitable cell.

Next, in step S104, the method of the present invention ignores the contents of lists of temporarily forbidden SNPNs, permanently forbidden SNPNs, 5GS forbidden tracking areas for roaming, 5GS forbidden tracking areas for regional provision of service, permanently forbidden SNPNs for access for localized services in the SNPN, and temporarily forbidden SNPNs for access for localized services in the SNPN. That is, the method of the present invention does not consider the contents of lists of temporarily forbidden SNPNs, permanently forbidden SNPNs, 5GS forbidden tracking areas for roaming, 5GS forbidden tracking areas for regional provision of service, permanently forbidden SNPNs for access for localized services in the SNPN, and temporarily forbidden SNPNs for access for localized services in the SNPN.

After that, since the contents of lists of temporarily forbidden SNPNs, permanently forbidden SNPNs, 5GS forbidden tracking areas for roaming, 5GS forbidden tracking areas for regional provision of service, permanently forbidden SNPNs for access for localized services in the SNPN, and temporarily forbidden SNPNs for access for localized services in the SNPN are ignored or are not considered, the method of the present invention initializes registration on the selected SNPN in step S106.

In some embodiments, if the method of the present invention selects the SNPN through the manual SNPN selection mode procedure for onboarding services in step S100, and determines that the selected SNPN belongs to a list of temporarily forbidden SNPNs for onboarding services, or permanently forbidden SNPNs for onboarding services, or 5GS forbidden tracking areas for roaming, or 5GS forbidden tracking areas for regional provision of service, the method of the present invention determines the selected SNPN is not a suitable cell.

Next, in step S104, the method of the present invention ignores the contents of lists of temporarily forbidden SNPNs for onboarding services, permanently forbidden SNPNs for onboarding services, 5GS forbidden tracking areas for roaming, and 5GS forbidden tracking areas for regional provision of service. That is, the method of the present invention does not consider the contents of lists of temporarily forbidden SNPNs for onboarding services, permanently forbidden SNPNs for onboarding services, 5GS forbidden tracking areas for roaming, and 5GS forbidden tracking areas for regional provision of service

After that, since the contents of lists of temporarily forbidden SNPNs for onboarding services, permanently forbidden SNPNs for onboarding services, 5GS forbidden tracking areas for roaming, and 5GS forbidden tracking areas for regional provision of service are ignored or are not considered, the method of the present invention initializes registration on the selected SNPN in step S106.

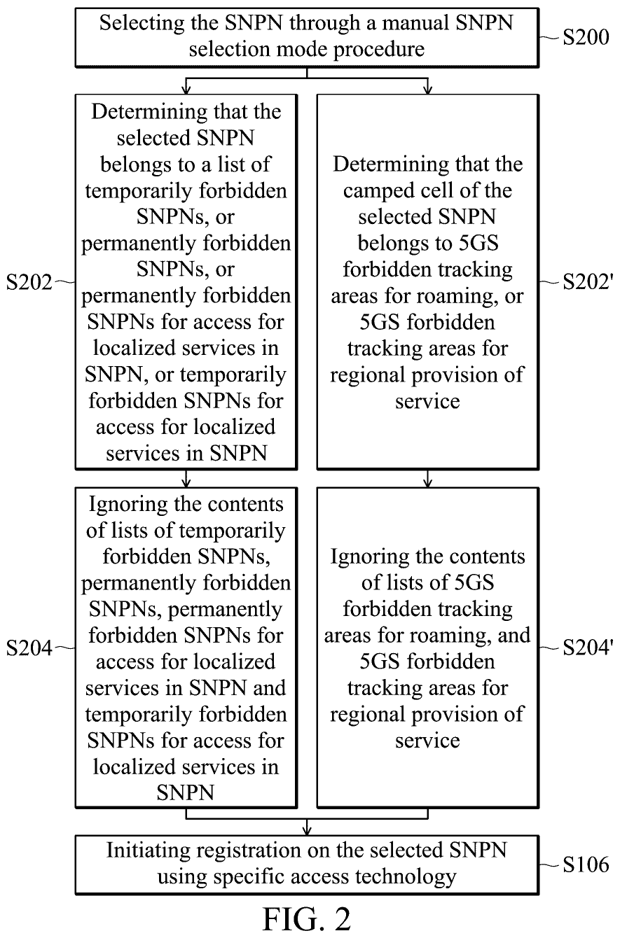

FIG. 2 shows a detail flow chart of the method to access the SNPN in the FSNPN list and the FTAI list in FIG. 1 in accordance with some embodiments of the present invention. As shown in FIG. 2, the selected SNPN is selected through a manual SNPN selection mode procedure (step S200). It is determined that the selected SNPN belongs to a list of temporarily forbidden SNPNs, or permanently forbidden SNPNs, or permanently forbidden SNPNs for access for localized services in SNPN, or temporarily forbidden SNPNs for access for localized services in SNPN (step S202), or it is determined that the selected SNPN belongs to a list of 5GS forbidden tracking areas for roaming, or 5GS forbidden tracking areas for regional provision of service (step S202′). The contents of lists of temporarily forbidden SNPNs, permanently forbidden SNPNs, permanently forbidden SNPNs for access for localized services in SNPN, and temporarily forbidden SNPNs for access for localized services in SNPN are ignored (step S204), and the contents of lists of 5GS forbidden tracking areas for roaming and 5GS forbidden tracking areas for regional provision of service are ignored (step S204′). Registration on the selected SNPN is initiated using specific access technology (step S106). In some embodiments, step S200 is the detail step of step S100. Steps S202 and S202′ are the detail step of step S102. Steps S204 and S204′ are the detail step of step S104. Since the contents of lists of temporarily forbidden SNPNs, permanently forbidden SNPNs, permanently forbidden SNPNs for access for localized services in SNPN, temporarily forbidden SNPNs for access for localized services in SNPN, 5GS forbidden tracking areas for roaming, and 5GS forbidden tracking areas for regional provision of service have been ignored, the present invention is able to initialize registration on the selected SNPN.

In some embodiments, if the present invention selects the selected SNPN through the manual SNPN selection mode procedure, and supports access to an SNPN providing access for localized services in the SNPN, the method of the present invention is able to indicate to a user whether an available SNPN is present in a list of temporarily forbidden SNPNs for access for localized services in the SNPN, or a list of permanently forbidden SNPNs for access for localized services in the SNPN associated with each entry of a list of subscriber data or public land mobile network (PLMN) data. That is, the SNPN providing access for localized services in the SNPN belongs to a list of permanently forbidden SNPNs for access for localized services in the SNPN, or a list of temporarily forbidden SNPNs for access for localized services in the SNPN associated with each entry of the list of subscriber data or PLMN data. If the answer is yes, the method of the present invention selects the available SNPN as the selected SNPN in step S200.

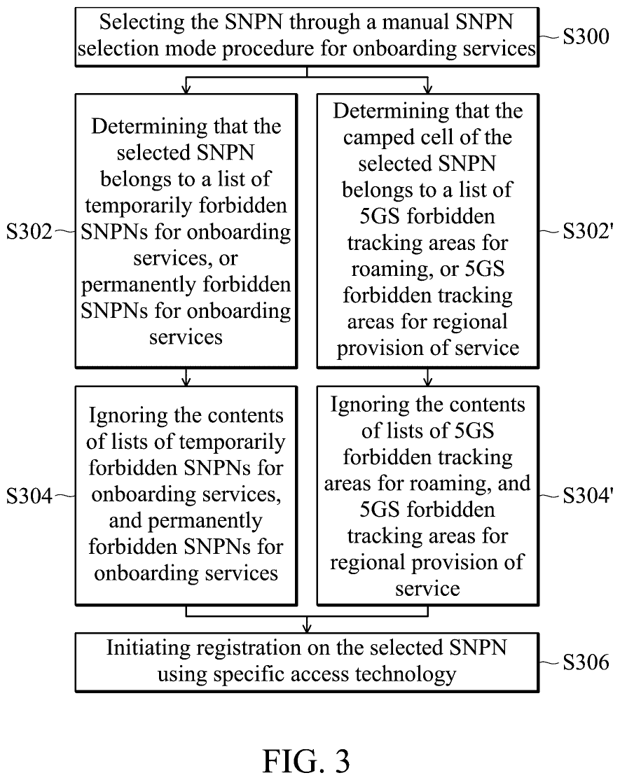

FIG. 3 shows a detail flow chart of the method to access the SNPN in the FTAI list in FIG. 1 in accordance with some embodiments of the present invention. As shown in FIG. 3, the selected SNPN is selected through a manual SNPN selection mode procedure for onboarding services (step S300). It is determined that the selected SNPN belongs to a list of temporarily forbidden SNPNs for onboarding services, or permanently forbidden SNPNs for onboarding services (step S302), or it is determined that the selected SNPN belongs to 5GS forbidden tracking areas for roaming, or 5GS forbidden tracking areas for regional provision of service (step S302′). The contents of lists of temporarily forbidden SNPNs for onboarding services and permanently forbidden SNPNs for onboarding services are ignored (step S304′), and the contents of lists of 5GS forbidden tracking areas for roaming, and 5GS forbidden tracking areas for regional provision of service are ignored (step S304′). Registration on the selected SNPN is initiated using specific access technology (step S106).

In some embodiments, step S300 is the detail step of step S100. Steps S302 and S302′ are the detail step of step S102. Steps S304 and S304′ are the detail step of step S104. Since the contents of lists of temporarily forbidden SNPNs for onboarding services, permanently forbidden SNPNs for onboarding services, 5GS forbidden tracking areas for roaming, and 5GS forbidden tracking areas for regional provision of service have been ignored, the present invention is able to initialize registration on the selected SNPN.

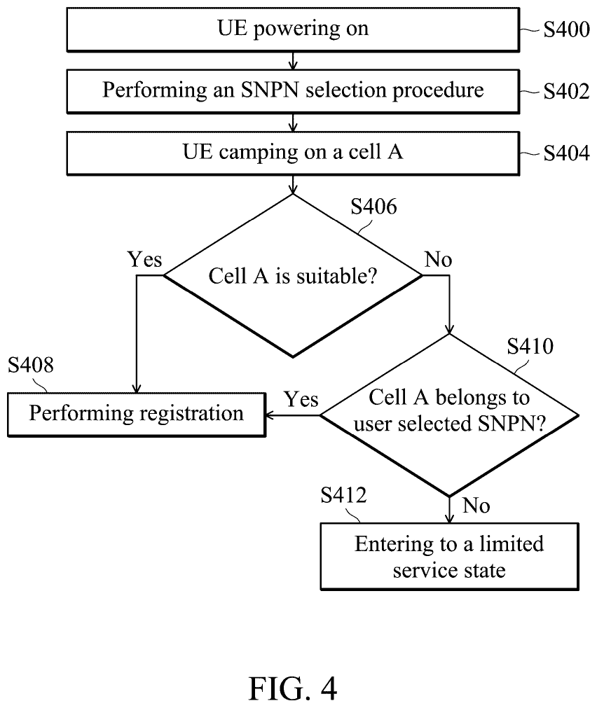

FIG. 4 shows a flow chart of a method to access the SNPN in the FSNPN list and the FTAI list in accordance with some embodiments of the present invention. As shown in FIG. 4, in step S400, UE is powered on. In step S402, a processor of the UE performs an SNPN selection procedure. In step S404, the UE camps on a cell A. In some embodiments, in step S402, the UE may perform step S200 in FIG. 2 or step S300 in FIG. 3. Next, in step S406, the processor of the UE determines whether the cell A is suitable or not. If the cell A is suitable, the UE performs registration in step S408. If the cell A is not suitable, the UE determines whether the cell A belongs to user selected SNPN or not in step S410. If the cell A belongs to user selected SNPN, the UE performs registration in step S408. If the cell A does not belong to user selected SNPN, the processor of the UE enters to a limited service state in step S412. In some embodiments, in step S406, the UE may perform steps S202 and S204 in FIG. 2 or steps S302 and S304 in FIG. 3.

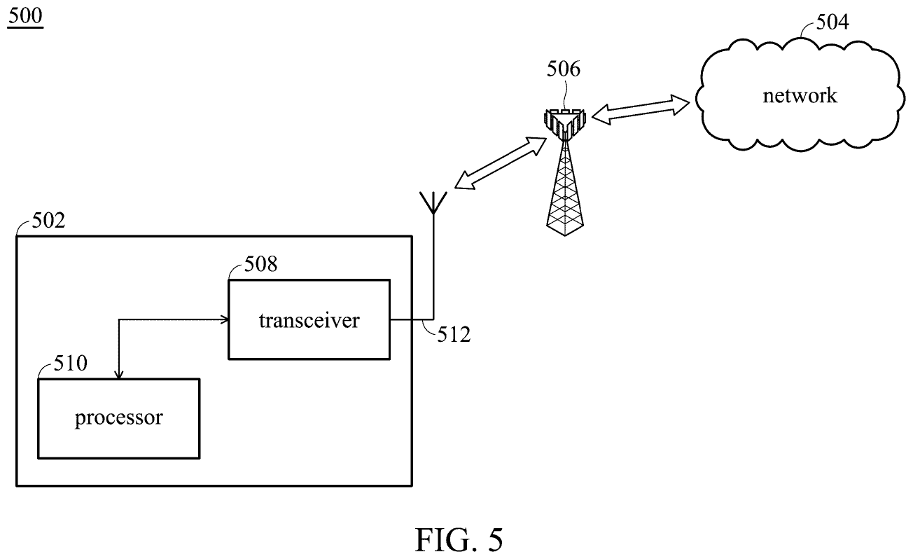

FIG. 5 shows schematic diagrams of a communication system 500 in accordance with some embodiments of the present invention. As shown in FIG. 5, the communication system 500 includes a UE 502, a network 804, and a base station 806. In some embodiments, the UE 502 may be a laptop, a tablet, or a smart phone, but the present invention is not limited thereto. In some embodiments, the UE 502 is able to access the network 504 through the base station 506. The UE 502 is connected with the base station 506 by Radio Resource Control (RRC) signaling, but the present invention is not limited thereto. In some embodiments, the base station 506 may be a gNB, but the present invention is not limited thereto.

In some embodiments, the UE 502 includes an antenna 512, a transceiver 508, and a processor 510. The transceiver 508 is electrically connected between the antenna 512 and the processor 510. The processor 510 may be a modem, but the present invention is not limited thereto. In some embodiments, the UE 502 further includes a memory (not shown) storing a plurality of codes. The processor 510 reads the codes stored in the memory to execute the steps as follows. The processor 510 performs a stand-alone non-Public network (SNPN) selection procedure to camp on a selected SNPN, for example, the network 504. The processor 510 determines that the selected SNPN is not a suitable cell, ignores contents in the FSNPN list and the FTAI list for the selected SNPN, and initializes registration on the selected SNPN. The selected SNPN is present in the FSNPN list and the FTAI list.

In some embodiments, the processor 510 selects the selected SNPN through a manual SNPN selection mode procedure. The processor 510 determines that the selected SNPN belongs to a list of temporarily forbidden SNPNs, or permanently forbidden SNPNs, or permanently forbidden SNPNs for access for localized services in SNPN, or temporarily forbidden SNPNs for access for localized services in SNPN, or 5GS forbidden tracking areas for roaming, or 5GS forbidden tracking areas for regional provision of service. The processor 510 ignores the contents of lists of temporarily forbidden SNPNs, permanently forbidden SNPNs, permanently forbidden SNPNs for access for localized services in SNPN, temporarily forbidden SNPNs for access for localized services in SNPN, 5GS forbidden tracking areas for roaming, and 5GS forbidden tracking areas for regional provision of service. The processor 510 then initializes registration on the selected SNPN.

In some embodiments, if the processor 510 selects the selected SNPN through the manual SNPN selection mode procedure, and the processor 510 supports access to an SNPN providing access for localized services in the SNPN, the processor 510 is able to indicate to a user whether an available SNPN is present in a list of temporarily forbidden SNPNs for access for localized services in the SNPN, or a list of permanently forbidden SNPNs for access for localized services in the SNPN associated with each entry of a list of subscriber data or public land mobile network (PLMN) data.

In some embodiments, if the processor 510 supports access to the SNPN providing access for localized services in the SNPN, the processor 510, the processor 510 determines that the selected SNPN belongs to a list of temporarily forbidden SNPNs, or permanently forbidden SNPNs, or 5GS forbidden tracking areas for roaming, or 5GS forbidden tracking areas for regional provision of service, or permanently forbidden SNPNs for access for localized services in the SNPN, or temporarily forbidden SNPNs for access for localized services in the SNPN. The processor 510 ignores the contents of lists of temporarily forbidden SNPNs, permanently forbidden SNPNs, 5GS forbidden tracking areas for roaming, 5GS forbidden tracking areas for regional provision of service, permanently forbidden SNPNs for access for localized services in the SNPN, and temporarily forbidden SNPNs for access for localized services in the SNPN. After that, the processor 510 initializes registration on the selected SNPN.

In some embodiments, the processor 510 selects the selected SNPN through a manual SNPN selection mode procedure for onboarding services. The processor 510 determines that the selected SNPN belongs to a list of temporarily forbidden SNPNs for onboarding services, or permanently forbidden SNPNs for onboarding services, or 5GS forbidden tracking areas for roaming, or 5GS forbidden tracking areas for regional provision of service. The processor 510 ignores the contents of lists of temporarily forbidden SNPNs for onboarding services, permanently forbidden SNPNs for onboarding services, 5GS forbidden tracking areas for roaming, and 5GS forbidden tracking areas for regional provision of service. After that, the processor 510 initializes registration on the selected SNPN.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method to access a stand-alone non-Public network (SNPN) in a forbidden SNPN (FSNPN) list or a forbidden tracking area identity (FTAI) list, applied to a mobile station (MS), comprising:
performing an SNPN selection mode procedure to camp on a cell of a user selected SNPN;
determining that the selected SNPN is present in the FSNPN list or a tracking area identity (TAI) of the camped cell is in the FTAI list; wherein an SNPN is selected by a user;
ignoring contents of the FSNPN list and the FTAI list for the selected SNPN, and
initiating registration on the selected SNPN using specific access technology.

2. The method as claimed in claim 1, wherein the step of performing the SNPN selection mode procedure to camp on the cell of the user selected SNPN comprises:
selecting the SNPN through a manual SNPN selection mode procedure.

3. The method as claimed in claim 1, wherein the step of performing the SNPN selection mode procedure to camp on the cell of the user selected SNPN comprises:
selecting the SNPN through a manual SNPN selection mode procedure for onboarding services.

4. The method as claimed in claim 2, wherein the step of determining that the selected SNPN is present in the FSNPN list or the TAI of the camped cell is in the FTAI list comprises:
determining that the selected SNPN belongs to a list of temporarily forbidden SNPNs, or permanently forbidden SNPNs, or permanently forbidden SNPNs for access for localized services in SNPN, or temporarily forbidden SNPNs for access for localized services in SNPN, or
determining that the camped cell of the selected SNPN belongs to 5GS forbidden tracking areas for roaming, or 5GS forbidden tracking areas for regional provision of service.

5. The method as claimed in claim 2, wherein the step of ignoring the contents of the FTAI list comprises:
ignoring the contents of lists of 5GS forbidden tracking areas for roaming, and 5GS forbidden tracking areas for regional provision of service.

6. The method as claimed in claim 2, wherein the step of ignoring the contents of the FSNPN list comprises:
ignoring the contents of lists of temporarily forbidden SNPNs, permanently forbidden SNPNs, permanently forbidden SNPNs for access for localized services in SNPN and temporarily forbidden SNPNs for access for localized services in SNPN.

7. A method to access a stand-alone non-Public network (SNPN), applied to a mobile station (MS), comprising:
supporting access to an SNPN providing access for localized services in SNPN;
wherein the MS is in a manual SNPN selection mode; and
indicating to a user whether available SNPNs are present in a list of temporarily forbidden SNPNs for access for localized services in SNPN, or a list of permanently forbidden SNPNs for access for localized services in SNPN associated with each entry of the list of subscriber data or public land mobile network (PLMN) subscription.

8. The method as claimed in claim 7, wherein the SNPN providing access for localized services in the SNPN belongs to a list of permanently forbidden SNPNs for access for localized services in SNPN, or a list of temporarily forbidden SNPNs for access for localized services in SNPN associated with each entry of the list of subscriber data or PLMN subscription.

9. The method as claimed in claim 7, wherein initiation of registration comprises an initial registration procedure or a mobility registration update procedure, or an initial registration procedure for onboarding services, or a mobility registration update procedure for onboarding services.

10. The method as claimed in claim 7, further comprising:
ignoring contents of lists of temporarily forbidden SNPNs for onboarding services and permanently forbidden SNPNs for onboarding services.

11. An electronic device, comprising:
a processor, configured to perform a stand-alone non-Public network (SNPN) selection mode procedure to camp on a cell of a user selected SNPN, determine that the selected SNPN is present in a forbidden SNPN (FSNPN) list or a tracking area identity (TAI) of the camped cell is in a forbidden tracking area identity (FTAI) list, ignore contents of the FSNPN list and the FTAI list for an SNPN selected by a user, and initiate registration on the selected SNPN;
wherein the selected SNPN is present in the FSNPN list or the FTAI list.

12. The electronic device as claimed in claim 11, wherein the processor selects the selected SNPN through a manual SNPN selection mode procedure.

13. The electronic device as claimed in claim 11, wherein the processor selects the selected SNPN through a manual SNPN selection mode procedure for onboarding services.

14. The electronic device as claimed in claim 12, wherein the processor determines that the selected SNPN belongs to a list of temporarily forbidden SNPNs, or permanently forbidden SNPNs, or permanently forbidden SNPNs for access for localized services in SNPN, or temporarily forbidden SNPNs for access for localized services in SNPN, or 5GS forbidden tracking areas for roaming, or 5GS forbidden tracking areas for regional provision of service.

15. The electronic device as claimed in claim 12, wherein the processor ignores the contents of lists of temporarily forbidden SNPNs, permanently forbidden SNPNs, permanently forbidden SNPNs for access for localized services in SNPN, temporarily forbidden SNPNs for access for localized services in SNPN, 5GS forbidden tracking areas for roaming, and 5GS forbidden tracking areas for regional provision of service.

16. The electronic device as claimed in claim 12, wherein when the processor supports access to a SNPN providing access for localized services in the SNPN, the processor indicates to a user whether an available SNPNs are present in a list of temporarily forbidden SNPNs for access for localized services in the second SNPN, or a list of permanently forbidden SNPNs for access for localized services in the SNPN associated with each entry of a list of subscriber data or public land mobile network (PLMN) subscription.

17. The electronic device as claimed in claim 16, wherein the SNPN providing access for localized services in the SNPN belongs to a list of permanently forbidden SNPNs for access for localized services in the second SNPN, or a list of temporarily forbidden SNPNs for access for localized services in the second SNPN associated with each entry of the list of subscriber data or PLMN subscription.

18. The electronic device as claimed in claim 16, wherein the processor determines that the selected SNPN belongs to a list of temporarily forbidden SNPNs, or permanently forbidden SNPNs, or 5GS forbidden tracking areas for roaming, or 5GS forbidden tracking areas for regional provision of service, or permanently forbidden SNPNs for access for localized services in the SNPN, or temporarily forbidden SNPNs for access for localized services in the SNPN.

19. The electronic device as claimed in claim 16, wherein the processor ignores the contents of lists of temporarily forbidden SNPNs, permanently forbidden SNPNs, 5GS forbidden tracking areas for roaming, 5GS forbidden tracking areas for regional provision of service, permanently forbidden SNPNs for access for localized services in the SNPN, and temporarily forbidden SNPNs for access for localized services in the SNPN.

20. The electronic device as claimed in claim 13, wherein the processor determines that the selected SNPN belongs to a list of temporarily forbidden SNPNs for onboarding services, or permanently forbidden SNPNs for onboarding services, or 5GS forbidden tracking areas for roaming, or 5GS forbidden tracking areas for regional provision of service.

21. The electronic device as claimed in claim 13, wherein the processor ignores the contents of lists of temporarily forbidden SNPNs for onboarding services, permanently forbidden SNPNs for onboarding services, 5GS forbidden tracking areas for roaming, and 5GS forbidden tracking areas for regional provision of service.
